(19) United States
(12) Patent Application Publication
(10) Pub. No.: US 2024/0264827 A1
(43) Pub. Date: Aug. 8, 2024

(54) APPARATUS, SYSTEM, AND METHOD FOR PROVIDING QUESTION AND ANSWER SERVICE INCLUDING SOURCE CODE EXPLANATION, AND METHOD FOR PROVIDING CHATBOT SERVICE USING SAME

(71) Applicant: LANGCODE INC., Seoul (KR)

(72) Inventors: Min Jun KIM, Seoul (KR); Yun Jae KOH, Seoul (KR); Ji Soo HAN, Seoul (KR)

(21) Appl. No.: 18/617,984

(22) Filed: Mar. 27, 2024

Related U.S. Application Data
(63) Continuation of application No. PCT/KR2022/005904, filed on Apr. 26, 2022.

(30) Foreign Application Priority Data
Sep. 28, 2021 (KR) 10-2021-0127652

(51) Int. Cl. G06F 8/73; G06F 40/268

(52) U.S. Cl. CPC G06F 8/73; G06F 40/268

(57) ABSTRACT

An embodiment provides a method of providing a question-answer service including source code commentary based on a communication connection between a terminal and a server. The method includes receiving, by the server, request data including source code text from the terminal; generating, by the server, commentary information of the source code text by analyzing the source code text based on a source code database; and performing, by the server, natural language processing on the request data based on the commentary information of the source code text to generate answer data corresponding to the request data and provide the answer data to the terminal.

### CROSS-REFERENCE TO RELATED APPLICATION

This application is a continuation of International Application No. PCT/KR2022/005904 filed on Apr. 26, 2022, which claims priority to Korean Patent Application No. 10-2021-0127652, filed on Sep. 28, 2021, the entire contents of which are herein incorporated by reference.

### BACKGROUND

The present disclosure relates to a device, system, and method for providing a question-answer service including source code commentary, and a chatbot service providing method using the same. More specifically, the present disclosure relates to a device, system, and method for providing a question-answer service configured to provide an answer including source code commentary included in text based on information obtained by analyzing source code included in the text as well as words having dictionary meanings included in the text, and a chatbot service providing method using the same.

A chatbot refers to an interactive messenger in which, when a question is input to a chat tool, such as a messenger, artificial intelligence provides an answer to the question as if talking to a person in everyday language. Recently, many companies at home and abroad have provided 24-hour customer support services and are introducing chatbots to reduce the cost and manpower consumed in the customer support services. Because it is convenient and efficient to obtain necessary knowledge or answers through chatbots from a customer's perspective, chatbots are evaluated as improving the quality of existing customer support services.

In general, customers input questions to chatbots as if chatting via a messenger, and the chatbot analyzes text data included in questions and provides answers corresponding to the questions based on trained data or the data stored in a database. In this case, when a question uses commonly used terms, the chatbot has a high recognition rate and may provide an appropriate answer to the question, but when the question is formed by using technical terms, an appropriate answer may not be provided.

For example, when a customer inputs a question, such as “how do you use a user search function?”, the chatbot understands the intention of “question about the user search function” and may provide an appropriate answer based on trained data or commentary of the user search function stored in the database. However, when a customer developing software inputs a question “how do you use” including source codes, in a case where the meaning of the source code “” is not stored in a database used by the chatbot, or the meaning of the word is stored differently from the meaning known to a customer, or a Korean meaning is derived by simple machine translation of an English text, a problem may occur in which the chatbot may not provide an appropriate answer to a question.

### SUMMARY

The present disclosure provides a device, system, and method for providing a question-answer service including source code commentary and configured to provide an answer including source code commentary included in a text based on information obtained by analyzing source code included in the text as well as words having dictionary meanings included in the text, and a chatbot service providing method using the same.

Technical problems to be solved by the present disclosure are not limited to the above-described technical problems, and other technical problems of the present disclosure may be derived from the following description.

An embodiment according to a first aspect of the present disclosure provides a method of providing a question-answer service including source code commentary based on a communication connection between a terminal and a server. The method includes receiving, by the server, request data including source code text from the terminal; generating, by the server, commentary information of the source code text by analyzing the source code text based on a source code database; and performing, by the server, natural language processing on the request data based on the commentary information of the source code text to generate answer data corresponding to the request data and provide the answer data to the terminal.

An embodiment according to a second aspect of the present disclosure provides a method of providing source code question-answer service by using a chatbot through a communication connection between a terminal and a server. The method includes receiving, by the server, request data including source code text from the terminal by using the chatbot; generating, by the server, commentary information of the source code text by analyzing the source code text based on a source code database; and performing, by the server, natural language processing on the request data based on the commentary information of the source code text to generate answer data corresponding to the request data and provide the answer data to the terminal by using the chatbot.

An embodiment according to a third aspect of the present disclosure provides a system for providing a question-answer service including source code commentary through a communication connection with a terminal. The system includes a communication module configured to transmit and receive information to and from the terminal, a memory storing a source code question-answer service program, and a processor configured to execute the source code question-answer service program stored in the memory. The processor is further configured to execute the source code question-answer service program to receive request data including source code text from the terminal through the communication module, generate commentary information of the source code text by analyzing the source code text based on a source code database, and perform natural language processing on the request data based on the commentary information of the source code text to generate answer data corresponding to the request data and provide the answer data to the terminal through the communication module.

An embodiment according to a fourth aspect of the present disclosure provides a device for providing a question-answer service including source code commentary. The device includes an input/output module, a memory storing a source code commentary service program, and a processor configured to execute the source code commentary service program stored in the memory. The processor is further configured to execute the source code commentary service program to receive request data including source code text through the input/output module, generate commentary information of the source code text by analyzing the source code text based on a source code database, and perform natural language processing on the request data based on the commentary information of the source code text to generate answer data corresponding to the request data and display the answer data through the input/output module.

### BRIEF DESCRIPTION OF THE DRAWINGS

Embodiments of the inventive concept will be more clearly understood from the following detailed description taken in conjunction with the accompanying drawings in which:

FIG. 1 is a diagram illustrating a system for providing a question-answer service including source code commentary and a terminal, according to an embodiment of the present disclosure;

FIG. 2 is a block diagram illustrating a configuration of a system for providing a question-answer service including source code commentary illustrated in FIG. 1;

FIG. 3 is a block diagram illustrating a configuration of the terminal illustrated in FIG. 1;

FIGS. 4 and 5 are diagrams illustrating examples that provide a question-answer service, according to an embodiment of the present disclosure;

FIG. 6 is a flowchart illustrating a sequence of a method of providing a question-answer service including source code commentary, according to another embodiment of the present disclosure;

FIGS. 7 to 10 are flowcharts illustrating detailed steps of some steps of the method illustrated in FIG. 6;

FIG. 11 is a flowchart illustrating a sequence of a method of providing a source code question answering service using a chatbot, according to another embodiment of the present disclosure; and

FIGS. 12 to 15 are diagrams illustrating detailed steps of some steps of the method illustrated in FIG. 11.

### DETAILED DESCRIPTION OF THE EMBODIMENTS

Hereafter, the present disclosure will be described in detail with reference to the accompanying drawings. However, the present disclosure may be implemented in many different forms and is not limited to the embodiments described herein. In addition, the accompanying drawings are only for easy understanding of the embodiments disclosed in the present specification, and the technical ideas disclosed in the present specification are not limited by the accompanying drawings. All terms, which include technical and scientific terms and are used herein, should be construed as meanings commonly understood by those skilled in the art in the technical field to which the present disclosure belongs. Terms defined in the dictionary should be construed as having additional meanings consistent with the related technical literature and currently disclosed content, and should not be construed in a very ideal or limited sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of ease of writing the specification, and do not have meanings or roles that are distinguished from each other by themselves. In addition, in describing the embodiments disclosed in the present specification, when it is determined that a detailed descriptions of related known technologies may obscure the gist of the embodiments disclosed in the present specification, the detailed descriptions are omitted.

Throughout the specification, when a portion is said to be “connected (coupled, in contact with, or combined)” with another portion, this includes not only a case where it is “directly connected (coupled, in contact with, or combined)”, but also a case where there is another member therebetween. In addition, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. As used herein, singular forms of expression should be construed to also include plural forms of expression, unless the contrary is clearly indicated.

FIG. 1 is a diagram illustrating a system for providing a question-answer service including source code commentary (hereinafter referred to as a “question-answer service providing system 100”) according to an embodiment of the present disclosure and a terminal 200.

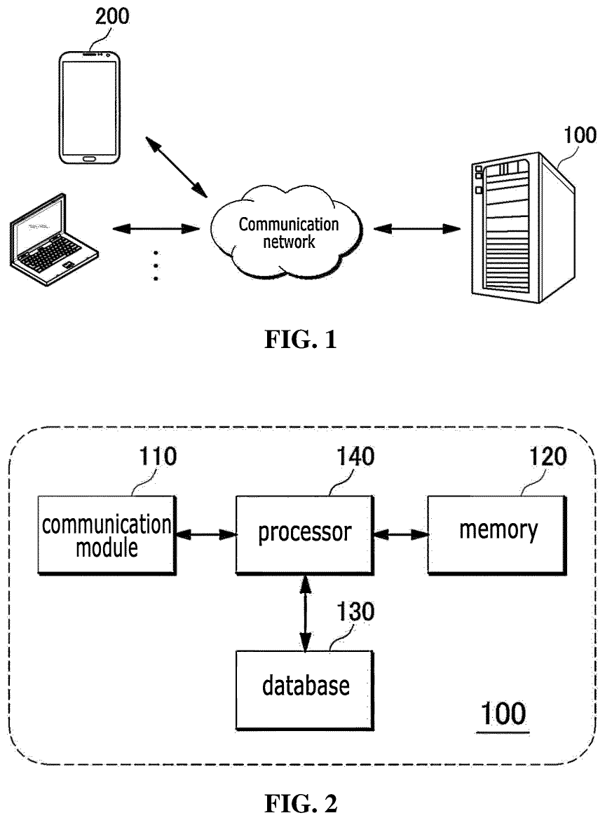

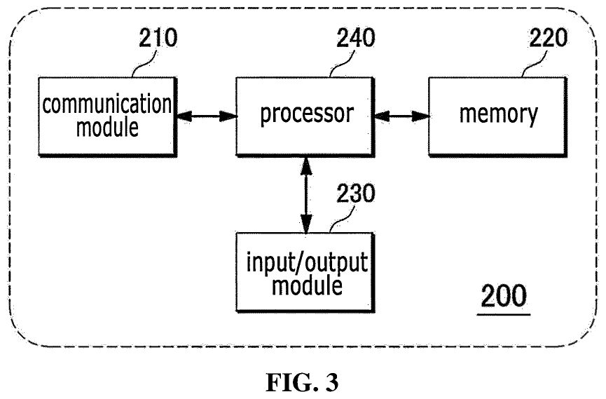

Referring to FIG. 1, the question-answer service providing system 100 is connected to the terminal 200 through a communication network. The question-answer service providing system 100 receives request data including a text from the terminal 200 through a communication connection to the terminal 200. The request data may include a question about source code interpretation. The question-answer service providing system 100 performs natural language processing based on the request data to generate an analysis result. The analysis result may include commentary information on a source code included in the request data. The question-answer service providing system 100 may generate answer data corresponding to the request data based on the analysis result and provide the answer data to the terminal 200. The terminal 200 may independently perform the above-described processes without interaction with the question-answer service providing system 100. For example, the terminal 200 may receive the request data from a user through an input/output module, such as a display or touchpad. The terminal 200 may generate an analysis result by performing natural language processing based on the request data. The terminal 200 may generate and display the analysis result as response data corresponding to the request data. The question-answer service providing system 100 and the terminal 200 may perform the above-described process by using a chatbot. In this case, the request data may be a question about a source code, and the answer data may be a chatbot answer including source code commentary information. The question-answer service providing system 100 and the terminal 200 will be described in more detail below with reference to FIGS. 2 and 3.

The question-answer service providing system 100 may be configured with a device, such as a server or the terminal 200 and may operate in a cloud computing service model, such as software as a service (SaaS), a platform as a service (PaaS), or an infrastructure as a service (IaaS). Also, the question-answer service providing system 100 may be built in the form of a server, such as a private cloud, public cloud, or hybrid cloud system.

The terminal 200 may refer to a handheld-based wireless communication device of all types, for example, a laptop computer or a desktop computer including a web browser, a wireless communication device that guarantees portability and mobility, a smart phone, a tablet personal computer (PC), or so on. Also, the communication network illustrated in FIG. 1 may be implemented by a wired network, such as a local area network (LAN), a wide area network (WAN), or a value added network (VAN), or any type of wireless network, such as a mobile radio communication network or a satellite communication network.

FIG. 2 is a block diagram illustrating a configuration of the question-answer service providing system 100 including source code commentary illustrated in FIG. 1. Referring to FIG. 2, the question-answer service providing system 100 may include a communication module 110, a memory 120, a processor 140, and a database 130.

The communication module 110 transmits and receives information to and from the terminal 200. The communication module 110 may include a device including hardware and software required to transmit and receive signals, such as control signals or data signals through wired or wireless connections to other network devices.

The memory 120 stores a source code question-answer service program. A name of the source code question-answer service program is set for the sake of convenience of description, and the name itself does not limit a function of the program. The memory 120 may store at least one of information and data input to the communication module 110, information and data required for functions performed by the processor 140, and data generated according to execution of the processor 140. The memory 120 should be interpreted as a general device for a non-volatile storage device that continuously retains the stored information even when power is not supplied thereto and a volatile storage device that requires power to maintain the stored information. Also, the memory 120 may perform a function of temporarily or permanently storing the data processed by the processor 140. The memory 120 may include magnetic storage media or flash storage media in addition to the volatile storage devices that require power to maintain the stored information, but the scope of the present inven0tion is not limited thereto.

The database 130 may store the data used by the question-answer service providing system 100. Also, the database 130 stores a text of materials related to source codes of one or more programming languages and text analysis information. In one example, the database 130 may store meta information and big data for analysis and commentary of request data including a source code text, such as word meaning information, source code name information, and source code commentary information. The database 130 may configure a part of the memory 120 but may be located outside the question-answer service providing system 100 without being located inside the question-answer service providing system 100. The database 130 may be referred to as a source code database 130.

The processor 140 may execute a source code question answering service program stored in the memory 120. The processor 140 may include various types of devices that control and process data. The processor 140 may refer to a data processing device which is built in hardware and has a physically structured circuit to perform functions expressed by codes or instructions included in a program. In one example, the processor 140 may include a microprocessor, a central processing unit (CPU), a processor core, a multiprocessor, an application-specific integrated circuit (ASIC), a field programmable gate array (FPGA), or so on, but the scope of the present disclosure is not limited thereto.

The processor 140 may execute the source code question-answer service program and perform following functions and procedures. The processor 140 receives request data including a source code text from the terminal 200 through the communication module 110. The processor 140 may analyze the source code text based on the source code database 130 and generates commentary information on the source code text. The processor 140 performs natural language processing on the request data based on the commentary information of a source code text to generate response data corresponding to the request data, and provides the response data to the terminal 200 through the communication module 110.

The processor 140 may execute a source code question-answer service program to perform morphological analysis on the text stored in the source code database 130 to extract text keywords. The processor 140 may perform sentence structure analysis on the text stored in the source code database 130 to analyze a relationship between the text keywords. The processor 140 may generate text analysis information including the text keywords and the relationships between text keywords. Here, the text analysis information may further include source code commentary information.

The processor 140 may set a source code keyword corresponding to a text keyword based on variable information, class information, and function information used in one or more programming languages. The processor 140 may generate source code commentary information including a name of a source code corresponding to the source code keyword, an abbreviation of the source code, and a relationship between the translation of the source code and the source code keywords.

The processor 140 may search whether source code commentary information corresponding to a source code text exists in the source code database 130, and may generate commentary information for the source code text including a source code commentary text, based on the source code commentary information corresponding to the source code text. Here, the source code commentary text may be formed in the same language as the text included in the request data. In one example, the processor 140 may receive additional request data for a text keyword included in the source code commentary text from the terminal 200 through the communication module 110, generate additional answer data corresponding to the additional request data, and provide the additional answer data to the terminal 200.

In one example, a process of building, by the processor 140, the source code database 130 and providing a source code question-answer service based thereon is as follows.

First, the processor 140 may receive text data included in a plan note, research note, requirements specification, meeting minutes, or so on related to the source code from users of the question-answer service providing system 100 or collect the text data through a linkage with an external service and a platform. The processor 140 may perform natural language processing, such as morphological analysis and sentence structure analysis on the collected text data, extract a subject, object, and predicate from each sentence to be set as text keywords, and extract a relationship and structure between the text keywords. The processor 140 may convert the extracted information between English and Korean by using a machine translation or the existing stored information, if necessary.

More specifically, when obtaining text data “viewing a post increases the view count”, the processor 140 may perform morphological analysis to extract “post”, “eul”, “view”, “view count”, “ga”, “increase”, and so on. Also, the processor 140 may extract a relationship between text keywords, such as a subject-predicate relationship between “post” and “view”, a subject-predicate relationship between “increase” and “view”, and so on, through sentence structure analysis. Furthermore, the processor 140 may extract a causal relationship that an “increase” in the “view count” occurs according to a condition “viewing” the “post”. The processor 140 may perform translation, such as “post”->“article”, “view count”->“view count”, “view”->“read”, and so on by using machine translation or existing translation data. The processor 140 may extract the following information from text data obtained based on the above comprehensive process.

Text keywords: “post”, “article”, “view count”, “view”, “read”, and “increase”. Keyword relationship: (subject-predicate) post-view, (subject-predicate) view count-increase, (causal) post view-view count increase

The above extraction may be extended not only to one sentence but also to multiple sentences and documents. For example, when there is a sentence “titles of posts already viewed are displayed in gray”, the processor 140 may also extract a subject-predicate relationship of “post-view” and extract a subject-predicate relationship of “title-display in gray”, and extract a causal relationship between “post-view” and “title-display in gray”. Based on the extraction and analysis results, the processor 140 may infer that “post-view” has a causal relationship with “view count-increase” and “title-display in gray”.

Next, the processor 140 may store and utilize the source code information transmitted by users of the question-answer service providing system 100 through a chatbot, a terminal, and so on, the source code information collected through linkage with an external service and platform in the source code database 130. The source code information may include a name, abbreviation, and commentary information of the source code. The processor 140 may extract relationships and structures between elements, such as variables, classes (objects), and functions (methods) declared and used in codes, based on the grammar of each programming language, from source code information. The processor 140 may generate a commentary of natural language for each line or logical unit of the source code by combining the extracted element, relationship, and structural information of the source code with the analysis information of the text data described above. The processor 140 may provide the generated commentary directly to a user as an answer by using a chatbot, or use the generated commentary as a kind of translation or index in future search and analysis.

More specifically, the question-answer service providing system 100 may store nouns (names) extracted from source code, such as variable names, class names, and function names used in programming languages, as one source code keyword to generate source code information. Here, nouns of low importance or temporarily used may be excluded by considering the type of nouns (whether the nouns are variable names or class names or so on), the frequency of use in the source code, exception rules, and so on. For example, function names basically provided in specific codes, such as alphabet that a programmer generally and temporarily use, such as “a”, “I”, “j”, “t”, “temp”, “tmp” or “a1”, and “t1”, and nouns of number combinations, Main( ), and so on, frameworks, and so on may be excluded from keywords. Also, when the class name is used once and does not fall under an exception rule, the class name is set as a keyword, but a variable may not be set as a keyword when a corresponding noun is used once and is not reused. For example, when there is a class called “TrainingChannel”, the question-answer service providing system 100 may register the “TrainingChannel” as a source code keyword. The question-answer service providing system 100 may segment consecutive string names without spaces by using upper and lower case letters, such as naming convention generally used in source code, that is, camelCase, PascalCase, Kebab-case, Snake_case, and so on, or distinguishment of special characters, such as “_”, “-”, “/”, “:”, and “.”. For example, “TrainingChannel” may be modified to “Training channel” and “last_login” may be modified to “last login”. The question-answer service providing system 100 may additionally perform the segmentation and transformation by using abbreviations, initials, patterns commonly used in codes, and patterns stored in existing knowledge graphs. For example, “Tmpl” may be modified to “Template”, “Cnt” may be modified to “Count”, “StudentNum” may be modified to “Student Number” & “The number of studnet”, and “SchoolList” may be modified to “School List” & “The list of school”. The question-answer service providing system 100 may perform translation of segmented keywords by considering the question-and-answer language of a chatbot. For example, when using a Korean chatbot, the question-answer service providing system 100 may perform transformation, such as “StudentCard”->“Student card”->“student card” or so on, and “SchoolList”->“School List”, “school list”, or so on.

The question-answer service providing system 100 may determine a relationship between extracted nouns (keywords) from a structure of a code and so on. Relationships between programming languages may include property, declaration, reference, operation, and so on. The property refers to a case where a variable or function is declared inside a specific class. For example, when a user class has a name and an email variable, a relationship, such as “user-name” and user-email” may mean the property. In a case of the property, the question-answer service providing system 100 may express a relationship by using “.” or input the property as a source code keyword. For example, when a student class has a name variable, the student class may be expressed as “Student.Name”. A source code keyword of “Student.Name” may be set as “Student name” and may be transformed into “The name of student”, “name of student”, or “student name”. The declaration refers to a case where a new variable is declared within a specific function. For example, when “newUser”, “userAddResult”, and so on are declared in a function called “AddNewUser”, relationships, such as “AddNewUser-newUser” and “AddNewUser-userAddResult” may mean declaration relationships. The reference refers to a case where there is a reference, such as calling another variable or function within a specific function. For example, when a function “GetStudentName” refers to a name property (variable) of a student class, a relationship, such as “GetStudentName-Student.Name” may mean a reference relationship. The operation refers to a case where variables are used together as operands of a specific operation, such as comparison or four arithmetic operations. For example, when there is a comparison operation called “minScore>student.Score” in a code, a relationship, such as “minScore-Student.Score” may mean an operation relationship.

The relationships described above are not fixed, and there may be multiple relationships even between the same nouns (keywords). Also, there may be not only directly primary relationships, but also secondary and tertiary relationships based thereon. This relationship may be used to extract keywords, set intent types, set entity types, and so on when a text included in input data is analyzed by the question-answer service providing system 100 and the terminal 200. For example, when there is a function called “GetStudentNames” in a school class, and this function refers to a variable (property) called name of the student class, the relationship may be set as follows. That is, “School-GetStudentNames” is a primary relationship and may be inferred as a property, “GetStudentNames-Student.Name” is a primary relationship and may be inferred as a reference, and “School-Student.Name” is a secondary relationship and may be inferred as both a property and a reference relationship. Alternatively, “Student.Name” is strictly viewed as a property relationship like “Student-Name”, and “School-Name” is a tertiary relationship and may be inferred as a property, reference, and property relationship.

FIG. 3 is a block diagram illustrating a configuration of the terminal 200 illustrated in FIG. 1. Referring to FIG. 3, the terminal 200 may include a memory 220, an input/output module 230, a processor 240, and a communication module 210. The communication module 210 may transmit and receive information to and from an external database or external device. Here, the external device may be the question-answer service providing system (100 of FIG. 1) described above. The memory 220 stores a source code commentary service program. A name of the source code commentary service program is set for the sake of convenience of description, and the name itself does not limit a function of the source code commentary service program. The memory 220 may further include a source code database. The source code database may store the data used by the terminal 200. The source code database stores text of documents related to source codes of one or more programming languages, and text analysis information thereon. In one example, the source code database may store meta information and big data for analysis and commentary of request data including source code text, such as word meaning information, source code name information, and source code commentary information. The source code database may form a part of the memory 220 but may but may be located outside the terminal 200 without being located inside the terminal 200.

The input/output module 230 may receive information or data transmitted to the terminal 200 from the outside or may output information or data stored in the terminal 200 to the outside. For example, the input/output module 230 may include a display, a touch pad, and so on. The processor 240 executes a source code commentary service program stored in the memory 220. Additional descriptions of the communication module 210, the memory 220, and the processor 240 are similar to the descriptions of the communication module (110 of FIG. 2), the memory (120 of FIG. 2), and the processor (140 of FIG. 2) previously described with reference to FIG. 2, and accordingly, redundant descriptions thereof are omitted.

The processor 240 may execute the source code commentary service program to perform the following functions and procedures. The processor 240 receives request data including source code text through the input/output module 230. The processor 240 analyzes the source code text based on the source code database and generates commentary information on the source code text. The processor 240 performs natural language processing on the request data based on the commentary information of the source code text to generate answer data corresponding to the request data. The processor 240 displays the answer data through the input/output module 230.

The processor 240 may extract text keywords by performing morphological analysis on the text stored in the source code database. The processor 240 may analyze a relationship between text keywords by performing sentence structure analysis on the text stored in the source code database. The processor 240 may generate text analysis information including the text keywords and the relationship between the text keywords. Here, the text analysis information may further include source code commentary information.

The processor 240 may set source code keywords corresponding to the text keywords based on variable information, class information, and function information used in one or more programming languages. The processor 240 may generate source code commentary information including the name of source code corresponding to the source code keyword, abbreviation of the source code, and a relationship between translation of the source code and the source code keywords.

The processor 240 may search whether the source code commentary information corresponding to the source code text exists in the source code database. The processor 240 may generate commentary information on the source code text including the source code commentary text, based on the source code commentary information corresponding to the source code text. Here, the source code commentary text may be formed in the same language as the text included in the request data. In one example, the processor 140 may receive additional request data for a text keyword included in the source code commentary text from the terminal 200 through the communication module 110, generate additional answer data corresponding to the additional request data, and provide the additional answer data to the terminal 200.

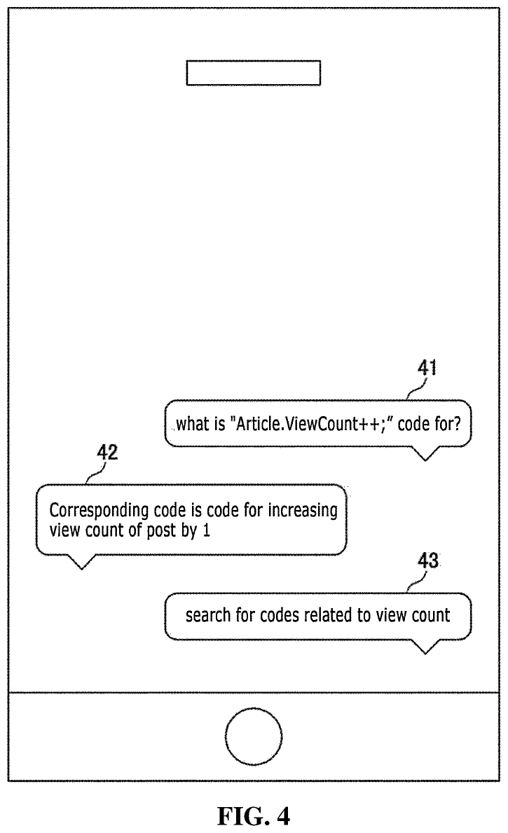

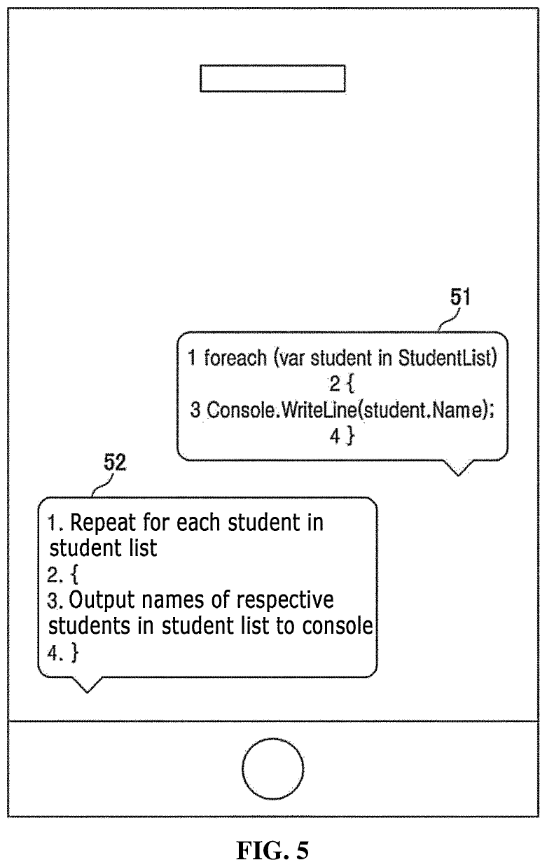

FIGS. 4 and 5 are diagrams illustrating examples of providing a question-answer service according to an embodiment of the present disclosure. Hereinafter, the above-described source code commentary process will be described in more detail with reference to FIGS. 4 and 5 along with FIGS. 1 to 3.

Referring to FIG. 4, a user of the question-answer service providing system 100 asks a question by sending request data to the question-answer service providing system 100 through a chatbot or the terminal 200, asking “What is the code for?”. The question-answer service providing system 100 may generate a commentary for a source code “article.ViewCount++;” and provide answer data to the user. In this case, a chatbot may be used, and answer data may be displayed on the user's terminal.

The question-answer service providing system 100 may analyze the request data through natural language processing of the data stored in the source code database 130 and the request data, and extract that a variable “article” is an “Article class” and that “ViewCount” is an “int (integer) type variable” existing in the “Article class”. Also, the question-answer service providing system 100 may confirm that an operator “++” means “an operation of adding 1 to a current value of the variable” in the grammar of a corresponding source code.

The question-answer service providing system 100 may initially generate source code commentary information, such as “view count of the article is increased by 1”. The question-answer service providing system 100 may check that there is a translation and mapping relationship between “post” and “article”, and similarly may check that there is a specific relationship between “view counts”. Therethrough, the question-answer service providing system 100 may modify the primary commentary to “view count of the post is increased by 1”.

That is, when a user asks the question-answer service providing system 100 through the terminal 200, a chatbot, or so on, “What code is “Article.ViewCount++;?” 41, the question-answer service providing system 100 may reply to the user by saying, “a corresponding code is a code for increasing a view count of the post by 1” 42 by using the chatbot. Questions and answers may be transmitted between the question-answer service providing system 100 and the terminal 200 in the form of text data through a chatbot messenger or so on.

Thereafter, the processor 140 may receive additional request data “search for codes related to view count” 43 from a user through the terminal 200 or a chatbot. The processor 140 may search the source code database 130 for commentaries including “view count” among pieces of source code commentary information in response to the additional request data, and provide a list of corresponding codes to the user through a chatbot.

Referring to FIG. 5, a user of the question-answer service providing system 100 may transmit the following request data to the question-answer service providing system 100 through a chatbot or terminal 200.
“1 foreach (var student in StudentList)
2 {
3 Console.WriteLine(student.Name);
4}”(51)

For a total of four source code lines included in the request data, the processor 140 may not provide commentary for lines 2 and 4, which have only {, } that is a symbol according to grammar and formal requirements of code, and this also applies to empty lines. In the request data, line 1 is a loop statement, and line 3 between { } is executed multiple times according to conditions of the loop statement in line 1. Since the processor 140 uses a variable “student” defined in line 1, the above information needs to be comprehensively considered when commentary for each line is provided.

The processor 140 may generate primary source code commentary information, such as “repeat for each student in StudentList” based on the grammar of a code “foreach” for line 1. The processor 140 may find appropriate translation and mapping information for “StudentList” from the source code database 130. The processor 140 may select the most frequently used student list among candidate students and student lists and transform primary commentary information as source code commentary information, such as “repeat for each student in the student list”.

The processor 140 may initially generate source code commentary information for line 3, such as “provide a student's name as an input to a Console.WriteLine method and execute the student's name”. Here, the processor 140 may infer that “Console.WriteLine” is a method (function) for outputting the given input to a console, based on the source code database 130 and transform the primary source code commentary information into secondary source code commentary information, such as “a student's name is output to a console”.

The processor 140 may infer name-“Name” mapping from the source code database 130 and transform the secondary source code commentary information into tertiary source code commentary information, such as “a student's name is output to a console”. Since “student” is a variable defined in line 1, the processor 140 may combine the variable to transform the tertiary source code commentary information into something like “a name of each student in the student list is output to a console”.

As a result, the processor 140 may generate answer data including source code commentary information corresponding to the request data as follows and provide the answer data to the terminal 200 by using a chatbot.
“1. Repeat for each student in the student list
2. {
3. Output names of respective students in the student list to a console
4.}”(52)

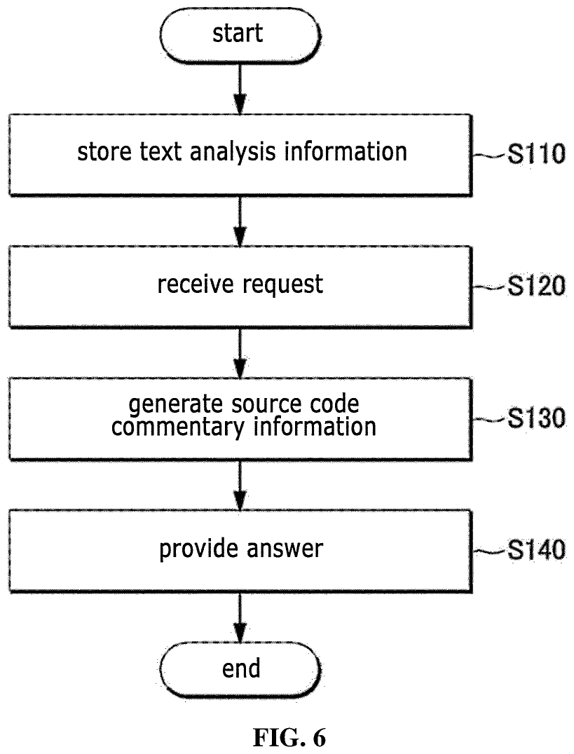

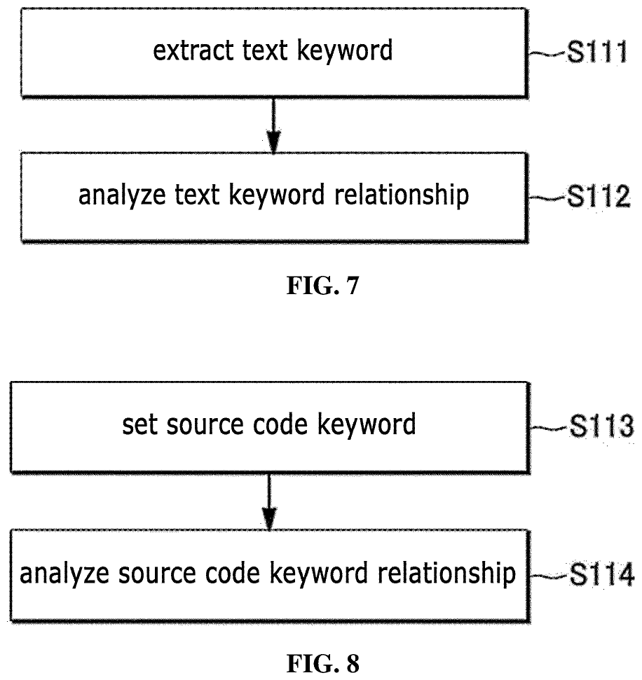

FIG. 6 is a flowchart illustrating a sequence of a method of providing a question-answer service including source code commentary, according to another embodiment of the present disclosure, and FIGS. 7 to 10 illustrate detailed steps for some steps of the method illustrated in FIG. 6. The method of providing a question-answer service including source code commentary to be described below may be performed by at least one of the question-answer service providing system 100 (illustrated in FIG. 1) including source code commentary and the terminal 200 (illustrated in FIG. 1) previously described with reference to FIGS. 1 to 5. Accordingly, the descriptions of the embodiments of the present disclosure previously described with reference to FIGS. 1 to 5 may be equally applied to embodiments described below, and redundant descriptions thereof are omitted below. The steps described below do not have to be performed in order, and the order of the steps may be set in various ways, and the steps may be performed almost simultaneously.

Referring to FIG. 6, a method of providing a question-answer service including source code commentary is a method performed through communication connection between a terminal and a system and may include step S120 of receiving a request, step S130 of generating source code commentary information, and step S140 of providing an answer, and may further include step S110 of storing text analysis information. Here, a server may be the question-answer service providing system 100 (illustrated in FIG. 1) including source code commentary described above, and the terminal may be the terminal 200 (illustrated in FIG. 1) described above.

Step S120 of receiving a request is a step in which the server receives request data including source code text from the terminal. Step S130 of generating source code commentary information is a step in which the server analyzes the source code text based on a source code database and generates commentary information on the source code text. Step S140 of providing an answer is a step in which the server performs natural language processing for the request data based on the commentary information of the source code text and generates answer data corresponding to the request data and provides the answer data to the terminal.

Step S110 of storing text analysis information is a step in which the server generates the text analysis information and stores the text analysis information in the source code database. In this way, the server may include a source code database which stores text of materials related to source code of one or more programming languages and text analysis information thereof.

Referring to FIG. 7, step S110 of storing the text analysis information may include step S111 of extracting text keywords and step S112 of analyzing a text keyword relationship. Step S111 of extracting the text keywords means a step in which a server extracts text keywords by performing morphological analysis on the text stored in the source code database. Step S112 of analyzing the text keyword relationship means a step in which the server performs sentence structure analysis on the text stored in the source code database to analyze a relationship between text keywords and generates text analysis information including the text keywords and the relationship between the text keywords. The text analysis information may further include source code commentary information. Since the text keywords are described above with reference to FIGS. 1 to 5, redundant descriptions thereof are omitted.

Referring to FIG. 8, step S110 of storing the text analysis information may include step S113 of setting source code keywords and step S114 of analyzing a source code keyword relationship. Step S113 of setting the source code keywords means a step in which a server sets source code keywords corresponding to text keywords based on variable information, class information, and function information used in one or more programming languages. Step S114 of analyzing the source code keyword relationship means a step in which the server generates source code commentary information including names of the source codes corresponding to the source code keywords, abbreviation of the source code, and a relationship between the translation of the source code and the source code keywords. Since the source code keywords are described above with reference to FIGS. 1 to 5, redundant descriptions thereof are omitted.

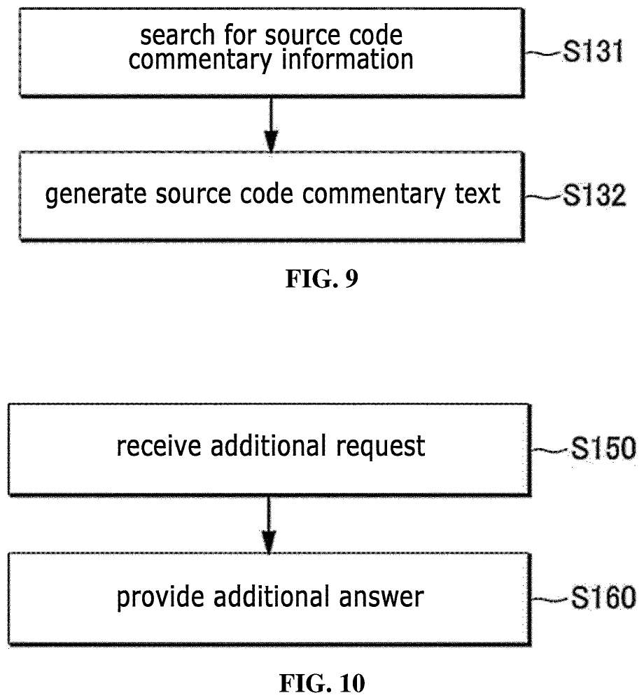

Referring to FIG. 9, step S130 of generating the source code commentary information may include step S131 of searching for the source code commentary information and step S132 of generating a source code commentary text. Step S131 of searching the source code commentary information means a step in which a server searches whether source code commentary information corresponding to the source code text exists in a source code database. Step S132 of generating the source code commentary text means a step in which the server generates commentary information of the source code text including the source code commentary text, based on the source code commentary information corresponding to the source code text. In one example, the source code commentary text may be formed in the same language as the text included in the request data.

Referring to FIG. 10, the method of providing a question-answer service including source code commentary may further include step S150 of receiving an additional request and step S160 of providing an additional answer. Step S150 of receiving an additional request means a step in which a server receives additional request data for text keywords included in the source code commentary text from a terminal. Step S160 of providing an additional answer means a step in which the server generates additional answer data corresponding to the additional request data and provides the additional answer data to the terminal.

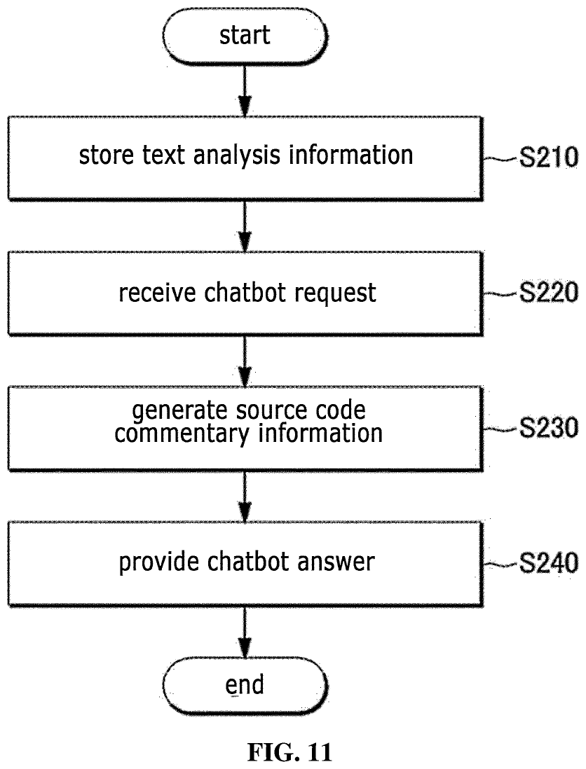

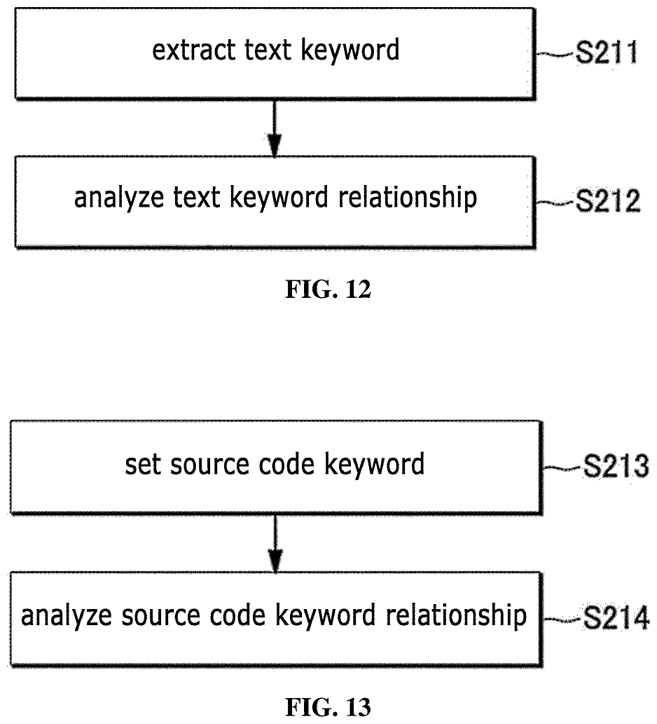

FIG. 11 is a flowchart illustrating a sequence of a method of providing a source code question-answer service using a chatbot according to another embodiment of the present disclosure, and FIGS. 12 to 15 illustrate detailed steps of some steps of the method illustrated in

FIG. 11. The method of providing a source code question-answer service using a chatbot described below may be performed by at least one of the question-answer service providing system 100 (illustrated in FIG. 1) including the source code commentary and the terminal 200 (illustrated in FIG. 1) previously described with reference to FIGS. 1 to 5. Accordingly, the descriptions of the embodiments of the present disclosure previously described with reference to FIGS. 1 to 5 may be equally applied to the embodiments to be described below, and redundant descriptions thereof are omitted below. The steps described below do not have to be performed in order, and the order of the steps may be set in various ways and may be performed almost simultaneously.

Referring to FIG. 11, the method of providing a source code question-answer service using a chatbot is a method performed through a communication connection between a terminal and a server and may include step S220 of receiving a chatbot request, step S230 of generating source code commentary information, and step S240 of providing a chatbot answer, and may further include step S210 of storing text analysis information. Here, the server may be the question-answer service providing system 100 (illustrated in FIG. 1) including the source code commentary described above, and the terminal may be the terminal 200 (illustrated in FIG. 1) described above.

Step S220 of receiving a chatbot request is a step in which the server receives request data including source code text from the terminal by using a chatbot. Step S230 of generating the source code commentary information is a step in which the server analyzes the source code text based on a source code database and generates commentary information of the source code text. Step S240 of providing a chatbot answer is a step in which the server performs natural language processing for the request data based on the commentary information of the source code text, generates answer data corresponding to the request data, and provides the answer data to the terminal by using the chatbot. Here, the chatbot may be artificial intelligence generated by the server.

Step S210 of storing text analysis information is a step in which the server generates the text analysis information and stores the text analysis information in a source code database. In this way, the server may include a source code database storing text of materials related to source codes of one or more programming languages and text analysis information thereof.

Referring to FIG. 12, step S120 of storing the text analysis information may include step S211 of extracting text keywords and step S212 of analyzing a text keyword relationship. Step S211 of extracting text keywords means a step in which a server extracts the text keywords by performing morphological analysis on the text stored in the source code database. Step S212 of analyzing text keyword relationship means a step in which the server performs sentence structure analysis on the text stored in the source code database, analyzes a relationship between the text keywords, and generates text analysis information including the text keywords and the relationship between the text keywords. The text analysis information may further include source code commentary information. Since descriptions of the text keywords are described above with reference to FIGS. 1 to 5, redundant descriptions thereof are omitted.

Referring to FIG. 13, step S210 of storing text analysis information may include step S213 of setting source code keywords and step of analyzing a source code keyword relationship. Step S213 of setting the source code keywords means a step in which a server sets source code keywords corresponding to the text keywords based on variable information, class information, and function information used in one or more programming languages. Step S214 of analyzing the source code keyword relationship means a step in which the server generates source code commentary information including names of the source codes corresponding to the source code keywords, abbreviation of the source codes, and a relationship between the translation of the source codes and the source code keywords. Since the source code keywords are described above with reference to FIGS. 1 to 5, redundant descriptions thereof are omitted.

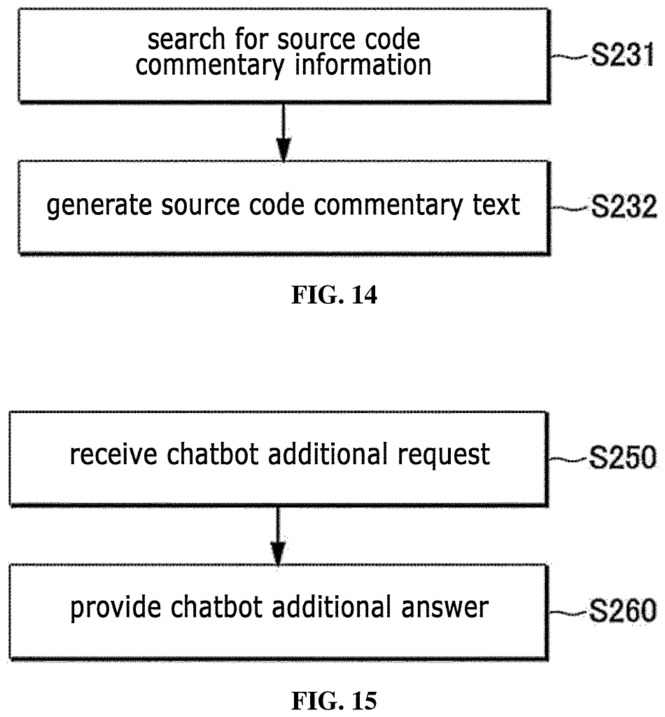

Referring to FIG. 14, step S230 of generating source code commentary information may include step S231 of searching for source code commentary information and step S232 of generating source code commentary text. Step S231 of searching for the source code commentary information means a step in which a server searches whether the source code commentary information corresponding to the source code text exists in a source code database. Step S232 of generating the source code commentary text means a step in which the server generates the source code commentary information including the source code commentary text based on the source code commentary information corresponding to the source code text. In one example, the source code commentary text may be formed in the same language as the text included in the request data.

Referring to FIG. 15, the method of providing a source code question-answer service using a chatbot may further include step S250 of receiving a chatbot additional request and step S260 of providing a chatbot additional answer. Step S250 of receiving the chatbot additional request means a step in which a server receives additional request data for text keywords included in the source code commentary text from the terminal by using a chatbot. Step S260 of providing the chatbot additional answer means a step in which the server generates the additional answer data corresponding to the additional request data by using the chatbot and provides the additional answer data to a terminal.

According to the present disclosure, an answer including commentary of source codes included in text may be provided based on information obtained by analyzing the source codes as well as words having dictionary meanings included in the text.

Also, according to the present disclosure, the meaning of text may be analyzed more accurately by performing not only dictionary semantic analysis but also source code analysis on words included in the text.

Also, according to the present disclosure, when words included in the text are not included in the dictionary in a process in which a question-and-answer chatbot performs text semantic analysis, source code analysis for the words may be performed to increase understanding of question and provide an appropriate answer to the question.

The method of providing a question-answer service including source code commentary and the method of providing a source code question-answer service using a chatbot, according to the embodiments of the present disclosure described above, may also be implemented in the form of a recording medium including instructions executable by a computer, such as program modules that are executed by the computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

Those skilled in the technical field to which the present disclosure belongs will be able to understand that the present disclosure may be easily transformed into another specific form without changing technical idea or essential features based on the above description. Therefore, the embodiments described above should be understood as illustrative in all respects and not limiting. The scope of the present disclosure is indicated by the patent claims described below, and all changes or modified forms derived from the meaning and scope of the claims and their equivalent concepts should be construed as being included in the scope of the present disclosure. The scope of the present disclosure is indicated by the following claims rather than the detailed description above, and the meaning and scope of the claims and all changes or modifications derived from the equivalent concepts should be interpreted as being included in the scope of the present disclosure.

The form for implementing the present disclosure is substantially the same as the previous best form for implementing the present disclosure.

The present disclosure may be applied to a natural language processing algorithm and software development industry using an artificial intelligence model, the artificial intelligence chatbot service industry, and so on, thereby having industrial applicability.

What is claimed is:

1. A method of providing a question-answer service including source code commentary through a communication connection between a terminal and a server, the method comprising:
receiving, by the server, request data including source code text from the terminal;
generating, by the server, commentary information of the source code text by analyzing the source code text based on a source code database; and
performing, by the server, natural language processing on the request data based on the commentary information of the source code text to generate answer data corresponding to the request data and provide the answer data to the terminal.

2. The method of claim 1, wherein
the server includes a source code database storing text of materials related to source codes of one or more programming languages and text analysis information on the text.

3. The method of claim 2, further comprising:
storing the text analysis information generated by the server in the source code database,
wherein the storing of the text analysis information includes:
extracting, by the server, text keywords by performing morphological analysis for the text stored in the source code database; and
analyzing, by the server, a relationship between the text keywords by performing sentence structure analysis for the text stored in the source code database and generating, by the server, the text analysis information including the text keywords and a relationship between the text keywords.

4. The method of claim 3, wherein
the text analysis information further includes source code commentary information, and
the storing of the text analysis information includes:
setting, by the server, source code keywords corresponding to the text keywords based on variable information, class information, and function information used in one or more programming languages; and
generating, by the server, the source code commentary information including names of source codes corresponding to the source code keywords, abbreviated names of the source codes, and a relationship between translation of the source codes and the source code keywords.

5. The method of claim 4, wherein the generating of the commentary information includes:
searching, by the server, whether source code commentary information corresponding to the source code text exists in the source code database; and
generating, by the server, the commentary information for the source code text including source code commentary text, based on source code commentary information corresponding to the source code text.

6. The method of claim 5, wherein
the source code commentary text is formed in the same language as the text included in the request data.

7. The method of claim 6, further comprising:
receiving, by the server, additional request data for text keywords included in the source code commentary text from the terminal, generating additional answer data corresponding to the additional request data, and providing the additional answer data to the terminal.

8. A method of providing source code question-answer service by using a chatbot through a communication connection between a terminal and a server, the method comprising:
receiving, by the server, request data including source code text from the terminal by using the chatbot;
generating, by the server, commentary information of the source code text by analyzing the source code text based on a source code database; and
performing, by the server, natural language processing on the request data based on the commentary information of the source code text to generate answer data corresponding to the request data and provide the answer data to the terminal by using the chatbot.

9. The method of claim 8, wherein
the server includes a source code database storing text of materials related to source codes of one or more programming languages and text analysis information on the text,
the method further comprises storing the text analysis information generated by the server in the source code database, and
the storing of the text analysis information includes:
extracting, by the server, text keywords by performing morphological analysis for the text stored in the source code database; and
analyzing, by the server, a relationship between the text keywords by performing sentence structure analysis for the text stored in the source code database and generating, by the server, the text analysis information including the text keywords and a relationship between the text keywords.

10. The method of claim 9, wherein
the text analysis information further includes source code commentary information, and
the storing of the text analysis information includes:
setting, by the server, source code keywords corresponding to the text keywords based on variable information, class information, and function information used in one or more programming languages; and
generating, by the server, the source code commentary information including names of source codes corresponding to the source code keywords, abbreviated names of the source codes, and a relationship between translation of the source codes and the source code keywords.

11. The method of claim 10, wherein the generating of the commentary information includes:
searching, by the server, whether source code commentary information corresponding to the source code text exists in the source code database; and
generating, by the server, the commentary information for the source code text including source code commentary text, based on source code commentary information corresponding to the source code text.

12. A system for providing a question-answer service including source code commentary through a communication connection with a terminal, the system comprising:
a communication module configured to transmit and receive information to and from the terminal;
a memory storing a source code question-answer service program; and
a processor configured to execute the source code question-answer service program stored in the memory,
wherein the processor is further configured to execute the source code question-answer service program to
receive request data including source code text from the terminal through the communication module, generate commentary information of the source code text by analyzing the source code text based on a source code database, and perform natural language processing on the request data based on the commentary information of the source code text to generate answer data corresponding to the request data and provide the answer data to the terminal through the communication module.

13. The system of claim 12, further comprising:
a source code database storing text of materials related to source codes of one or more programming languages and text analysis information on the text,
wherein the processor is further configured to execute the source code question-answer service program to extract text keywords by performing morphological analysis for the text stored in the source code database, and analyze a relationship between the text keywords by performing sentence structure analysis for the text stored in the source code database and generating, by the server, the text analysis information including the text keywords and a relationship between the text keywords.

14. The system of claim 13, wherein
the text analysis information further includes source code commentary information, and
the processor is further configured to execute the source code question-answer service program to set source code keywords corresponding to the text keywords based on variable information, class information, and function information used in one or more programming languages, and generate the source code commentary information including names of source codes corresponding to the source code keywords, abbreviated names of the source codes, and a relationship between translation of the source codes and the source code keywords.

15. The system of claim 14, wherein
the processor is further configured to execute the source code question-answer service program to search whether source code commentary information corresponding to the source code text exists in the source code database, and generate the commentary information for the source code text including source code commentary text, based on source code commentary information corresponding to the source code text.

16. A device for providing a question-answer service including source code commentary, the device comprising:
an input/output module;
a memory storing a source code commentary service program; and
a processor configured to execute the source code commentary service program stored in the memory,
wherein the processor is further configured to execute the source code commentary service program to
receive request data including source code text through the input/output module, generate commentary information of the source code text by analyzing the source code text based on a source code database, and perform natural language processing on the request data based on the commentary information of the source code text to generate answer data corresponding to the request data and display the answer data through the input/output module.

17. The device of claim 16, further comprising:
a source code database storing text of materials related to source codes of one or more programming languages and text analysis information on the text,
wherein the processor is further configured to execute the source code commentary service program to extract text keywords by performing morphological analysis for the text stored in the source code database, and analyze a relationship between the text keywords by performing sentence structure analysis for the text stored in the source code database and generating, by the server, the text analysis information including the text keywords and a relationship between the text keywords.

18. The device of claim 17, wherein
the text analysis information further includes source code commentary information, and
the processor is further configured to execute the source code commentary service program to set source code keywords corresponding to the text keywords based on variable information, class information, and function information used in one or more programming languages, and generate the source code commentary information including names of source codes corresponding to the source code keywords, abbreviated names of the source codes, and a relationship between translation of the source codes and the source code keywords.

19. The device of claim 18, wherein
the processor is further configured to execute the source code commentary service program to search whether source code commentary information corresponding to the source code text exists in the source code database, and generate the commentary information for the source code text including source code commentary text, based on source code commentary information corresponding to the source code text.

20. A non-transitory computer-readable recording medium in which a computer program for performing the method of providing the question-answer service including the source code commentary according to claim 1 is recorded.
